(19) United States
(12) Patent Application Publication
(10) Pub. No.: US 2006/0066773 A1
(43) Pub. Date: Mar. 30, 2006

(54) Vertical backlight module of LCD television

(76) Inventor: Kuo Jui Huang, Chia-Yi Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/951,705

(22) Filed: Sep. 29, 2004

(51) Int. Cl. G02F 1/1335

(52) U.S. Cl. 349/64

(57) ABSTRACT

A vertical backlight module of LCD television, including a reflective shade and multiple self-energized light sources arranged in the reflective shade. A backlight board is disposed on one side of the reflective shade. The backlight board includes a light-guiding board and several scattering plates. Multiple transflective layers are disposed on the backlight board respectively corresponding to positions of the light sources for controlling penetrability of light.

### BACKGROUND OF THE INVENTION

The present invention is related to a vertical backlight module of LCD television, and more particularly to a vertical backlight module of LCD television, which has thinner thickness and is able to achieve better evenness of lighting and enhance brightness.

FIG. 5 shows a conventional vertical backlight module of LCD television. Multiple CCFL lamp tubes 5 are arranged in a reflective shade 51. A backlight board 6 is disposed on one side of the reflective shade 51 corresponding to the lamp tubes 5. The backlight board 6 includes a light-guiding board 61 and several scattering plates 62 piled on the light-guiding board 61. The lamp tubes 5 emit light onto the backlight board 6. The light-guiding board 61 and several scattering plates 62 of the backlight board 6 scatter the light so as to achieve a larger and more even face light source.

In the conventional vertical backlight module, the light sources are multiple lamp tubes 5 arranged at intervals. The brightness between the lamp tubes 5 is uneven so that bright and dark stripes will be produced. As a result, the evenness of lighting of the backlight board 6 is poor. In the case that the brightness energy directly projected by the lamp tubes 5 onto the backlight board 6 is 100%, while the brightness energy between the lamp tubes 5 is only 50%, the bright and dark stripes will be produced on the backlight board 6 to result in poor evenness of lighting.

In order to improve the problem of poor evenness of lighting, conventionally the backlight board 6 is thickened and the number of the scattering plates 62 is increased. However, the thickness of the backlight module is increased and the cost for the material is relatively high. Moreover, after the thickness of the backlight board 6 is increased, the brightness of the backlight module will be reduced as a whole. Therefore, the lighting efficiency of the backlight module will be lowered.

### SUMMARY OF THE INVENTION

It is therefore a primary object of the present invention to provide a vertical backlight module of LCD television. The backlight module includes a reflective shade and multiple self-energized light sources arranged in the reflective shade. A backlight board is disposed on one side of the reflective shade. The backlight board includes a light-guiding board and several scattering plates piled on the light-guiding board. Multiple transflective layers are disposed on the backlight board respectively corresponding to positions of the light sources for controlling penetrability of light. By means of the transflective layers, the energy of the penetrating light of the region of the light sources and the region free from the light sources can be directly modulated. Therefore, better evenness of lighting of the backlight board is achievable.

It is a further object of the present invention to provide the above the vertical backlight module of LCD television. The light of the light sources is partially reflected by the transflective layers onto the reflective shade. Then the reflective shade reflects the light onto the backlight board so as to enhance the brightness thereof. Therefore, the lighting efficiency of the backlight module is increased.

The present invention can be best understood through the following description and accompanying drawings wherein:

### BRIEF DESCRIPTION OF THE DRAWINGS

FIG. 1 shows the structure of a first embodiment of the present invention;

FIG. 2 shows that the present invention can achieve even brightness;

FIG. 3 shows the structure of a second embodiment of the present invention;

FIG. 4 shows the structure of a third embodiment of the present invention; and

FIG. 5 shows the structure of a conventional backlight module which can hardly achieve even brightness.

### DETAILED DESCRIPTION OF THE PREFERRED EMBODIMENTS

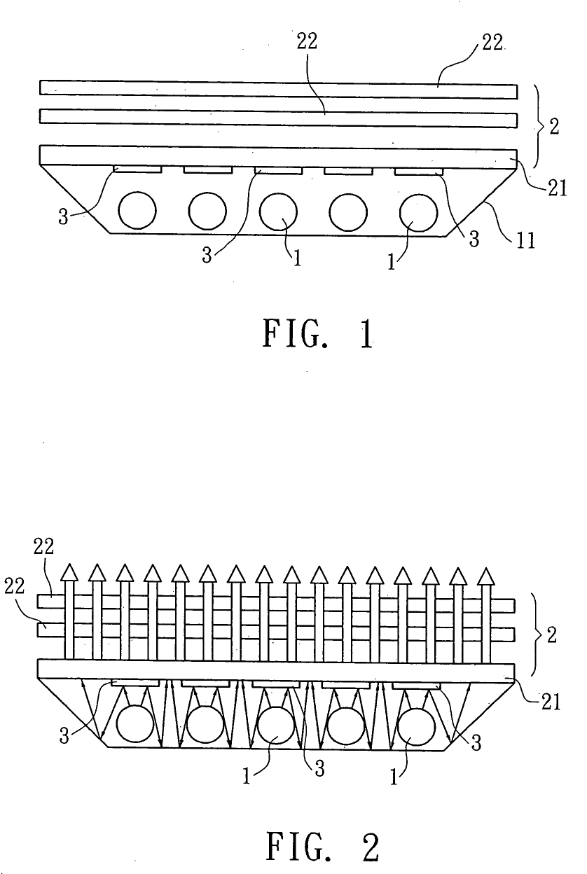

Please refer to FIGS. 1 and 2. The vertical backlight module of LCD television of the present invention includes a reflective shade 11 and multiple self-energized light sources 1 arranged in the reflective shade 11. In this embodiment, the light sources 1 are CCFL lamp tubes. A backlight board 2 is disposed on one side of the reflective shade 11. The backlight board 2 includes a light-guiding board 21 and several scattering plates 22 piled on the light-guiding board 21. Multiple transflective layers 3 are disposed on the backlight board 2 respectively corresponding to the light sources 1 for controlling the penetrability of light. In this embodiment, several transflective layers 3 are deposited on one face of the light-guiding board 21 of the backlight board 2 adjacent to the light sources 1. The positions of the transflective layers 3 respectively correspond to the positions of the light sources 1. Alternatively, several transflective layers 3 can be attached to the light-guiding board 21 respectively corresponding to the light sources 1.

Apart of light will penetrate through the transflective layers 3 and a part of light will be reflected by the transflective layers 3. Accordingly, the penetrability of the light is controllable. The light emitted from the light sources 1 will partially penetrate through the corresponding transflective layers 3 and project to the backlight board 2. Accordingly, the brightness of backlight board 2 in both the position of the light sources 1 and the position free from the light sources 1 will be unified. On the other hand, the light is partially reflected by the transflective layers 3 onto the reflective shade 11. Then the reflective shade 11 reflects the light onto the backlight board 2 so as to enhance the lighting efficiency thereof.

The transflective layers 3 are disposed on the backlight board 2 respectively corresponding to the light sources 1 for controlling the penetrability of light. Therefore, the energy of the penetrating light of the region of the light sources 1 and the region free from the light sources 1 can be directly modulated. The original 100% light energy of the region can be reduced to 80%, while the original 50% light energy of the region can be increased to 80%. Therefore, the backlight board 2 can entirely have 80% light energy so as to achieve better evenness of lighting of the backlight board 2.

Moreover, the light of the light sources 1 is partially reflected by the transflective layers 3 onto the reflective shade 11. Then the reflective shade 11 reflects the light onto the backlight board 2 so as to enhance the brightness thereof. Therefore, the lighting efficiency of the backlight module is increased.

In conclusion, by means of the transflective layers 3 corresponding to the light sources, better evenness of lighting and brightness of the backlight board is achieved. In addition, the lighting efficiency of the backlight module is increased.

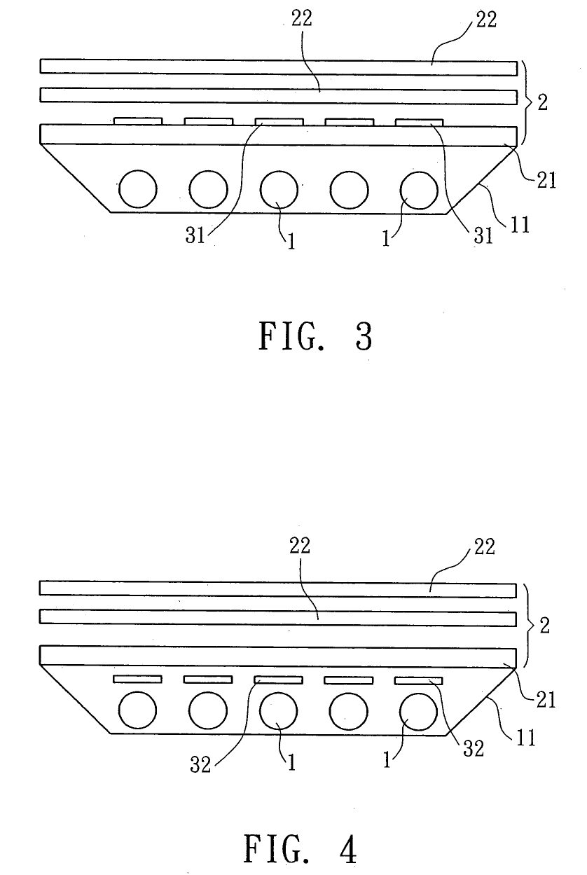

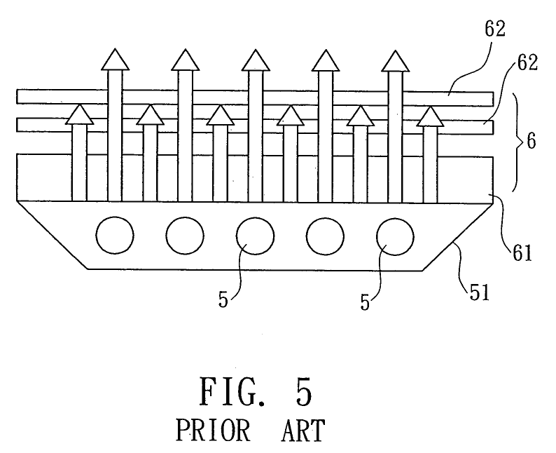

FIG. 3 shows a second embodiment of the present invention, in which the transflective layers 3 are disposed on one face of the light-guiding board 21 of the backlight board 2 distal from the light sources 1 corresponding to the positions thereof. FIG. 4 shows a third embodiment of the present invention, in which the transflective layers 3 are disposed between the light-guiding board 21 of the backlight board 2 and the light sources 1 corresponding to the positions of the light sources 1. These arrangements of the transflective layers 3 can achieve the same function as the first embodiment.

The above embodiments are only used to illustrate the present invention, not intended to limit the scope thereof. Many modifications of the above embodiments can be made without departing from the spirit of the present invention.

What is claimed is:

1. A vertical backlight module of LCD television, comprising a reflective shade and multiple self-energized light sources arranged in the reflective shade, a backlight board being disposed on one side of the reflective shade, the backlight board including a light-guiding board and several scattering plates piled on the light-guiding board, multiple transflective layers being disposed on the backlight board respectively corresponding to positions of the light sources for controlling penetrability of light.

2. The vertical backlight module of LCD television as claimed in claim 1, wherein the transflective layers are disposed on one face of the light-guiding board of the backlight board adjacent to the light sources respectively corresponding to the positions of the light sources 1.

3. The vertical backlight module of LCD television as claimed in claim 1, wherein the transflective layers are disposed on one face of the light-guiding board of the backlight board distal from the light sources respectively corresponding to the positions of the light sources 1.

4. The vertical backlight module of LCD television as claimed in claim 1, wherein the transflective layers are disposed between the light-guiding board of the backlight board and the light sources respectively corresponding to the positions of the light sources.

5. The vertical backlight module of LCD television as claimed in claim 1, wherein the light sources are CCFL lamp tubes.
